(19) United States
(12) Patent Application Publication
(10) Pub. No.: US 2004/0225707 A1
(43) Pub. Date: Nov. 11, 2004

(54) Systems and methods for combining a slow data stream and a fast data stream into a single fast data stream

(76) Inventors: Huai-Ter Victor Chong, Dallas, TX (US); Richard W. Adkisson, Dallas, TX (US)

Correspondence Address: HEWLETT-PACKARD COMPANY, Intellectual Property Administration, P.O. Box 272400, Fort Collins, CO, 80527-2400, US

(21) Appl. No.: 10/434,656

(22) Filed: May 9, 2003

(51) Int. Cl. G06F 15/16

(52) U.S. Cl. 709/200

(57) ABSTRACT

One method combines a slow data stream with one or more fast data streams into a single fast data stream, including: processing queued transactions of the fast data streams into the single fast data stream; determining when there are no queued transactions of the fast data streams; determining existence of a transaction from the slow data stream; if the transaction has data packets, inserting the transaction into the single fast data stream when there are no queued transactions; and if the transaction has no data packets, inserting the transaction into the single fast data stream. Systems are also disclosed to combine a slow data stream with one or more fast data streams to form a single fast data stream.

### RELATED APPLICATIONS

This application is related to the following commonly owned and co-filed U.S. patent applications, filed May 8, 2003 and incorporated herein by reference: SYSTEMS AND METHODS FOR GENERATING TRANSACTION IDENTIFIERS (Attorney Docket 200300029); SYSTEMS AND METHODS FOR DELETING TRANSACTIONS FROM MULTIPLE FAST DATA STREAMS (Attorney Docket 200300028); SYSTEMS AND METHODS TO INSERT BROADCAST TRANSACTIONS INTO A FAST DATA STREAM OF TRANSACTIONS (Attorney Docket 200300027); and SYSTEMS AND METHODS FOR INCREASING TRANSACTION ENTRIES IN A HARDWARE QUEUE (Attorney Docket 200300011).

### BACKGROUND

In a high speed server consisting of multiple processors, a core electronics complex, also known as a “chipset,” provides for communication between processors and various support devices (e.g., random access memory and disk drives etc.). The support devices communicate with the chipset using fast and slow data streams over multiple busses. Information in the data stream is contained in transactions constructed from one header packet and zero, one or more data packets.

The chipset operates to combine the fast and slow data streams into a single fast data stream. If header and data packets are contiguous for all transactions, a transaction received from the slow data stream may be inserted into the fast data stream in between transactions of the fast data stream.

The chipset may further combine multiple fast data streams into a single fast data stream and receive transactions from two or more fast data streams simultaneously, resulting in interleaving of header and data packets. The relative ordering of data packets within a transaction must be maintained; it therefore becomes difficult in this instance to insert a transaction from a slow data stream in between the interleaved transactions of the fast data streams.

To optimize bandwidth of the fast data streams, and to reduce latency associated with the fast transactions, the prior art chipset separately handles header and data packets and outputs header packets in the order received; however, it does not necessarily output the header packet at the same time as the data packets. Ordering of the header packet in relation to the data packets on output is therefore indeterminate, even though the data packets are also output in the order received (these data packets may be interleaved with multiple transactions on input). Accordingly, the insertion of a transaction from the slow data stream into the fast data stream must ensure ordering of the transaction's header and data packets without (a) disturbing transactions already being processed within the chipset, and (b) increasing latency associated with the transactions of the fast data stream.

Prior art solutions typically abort any in-progress transactions from the fast data streams, insert transactions from the slow data stream, and then restart the aborted transactions from the fast data streams. Such solutions also utilize complicated logic and are expensive to implement.

### SUMMARY OF THE INVENTION

In one embodiment, a method combines a slow data stream with one or more fast data streams into a single fast data stream, including: processing queued transactions of the fast data streams into the single fast data stream; determining when there are no queued transactions of the fast data streams; determining existence of a transaction from the slow data stream; if the transaction has data packets, inserting the transaction into the single fast data stream when there are no queued transactions; and if the transaction has no data packets, inserting the transaction into the single fast data stream.

In another embodiment, a system combines a slow data stream with one or more fast data streams to form a single fast data stream. A header processor processes header packets of transactions of the slow data stream and the fast data streams into the single fast data stream. A data processor processes data packets of transactions of the slow data stream and the fast data streams into the single fast data stream. The header processor reads a header packet of a transaction from the slow data stream to determine a number of data packets associated the transaction. If there are data packets associated with the transaction and there are no queued transactions, the header processor inserts the header packet into the single fast data stream after completion of current transactions of the fast data streams by the data processor. If there are no data packets associated with the transaction, the header processor inserts the header packet into the single fast data stream without waiting for completion of the current transactions.

In another embodiment, a system combines a slow data stream with one or more fast data streams into a single fast data stream, including: means for processing queued transactions of the fast data streams into the single fast data stream; means for determining when there are no queued transactions of the fast data streams; means for determining existence of a header packet of a transaction from the slow data stream;

means for processing a header packet of the transaction from the slow data stream to the single fast data stream when there are no data packets associated with the transaction; and means for processing one or more data packets of the transaction from the slow data stream into the single fast data stream when there are no queued or current transactions.

### BRIEF DESCRIPTION OF THE FIGURES

FIG. 1 is a block diagram showing one system that combines a slow data stream and one or more fast data streams into a single fast data stream.

FIG. 2 is a block diagram illustrating three exemplary transactions constructed from header packets and data packets.

FIG. 3 is a block schematic diagram showing further exemplary detail of the chipset of FIG. 1.

FIG. 4 is a diagram showing exemplary state machine transition logic that handles insertion of transactions received from a slow data stream into a single fast data stream.

FIG. 5 is a block diagram illustrating insertion of a transaction from a slow data stream into a single fast data stream containing information from two fast data streams.

FIG. 6 is a flowchart illustrating one process for inserting transactions received from a slow data stream into a single fast data stream.

FIG. 7 is a flowchart illustrating one process for inserting transactions received from a slow data stream into a single fast data stream.

### DETAILED DESCRIPTION OF THE FIGURES

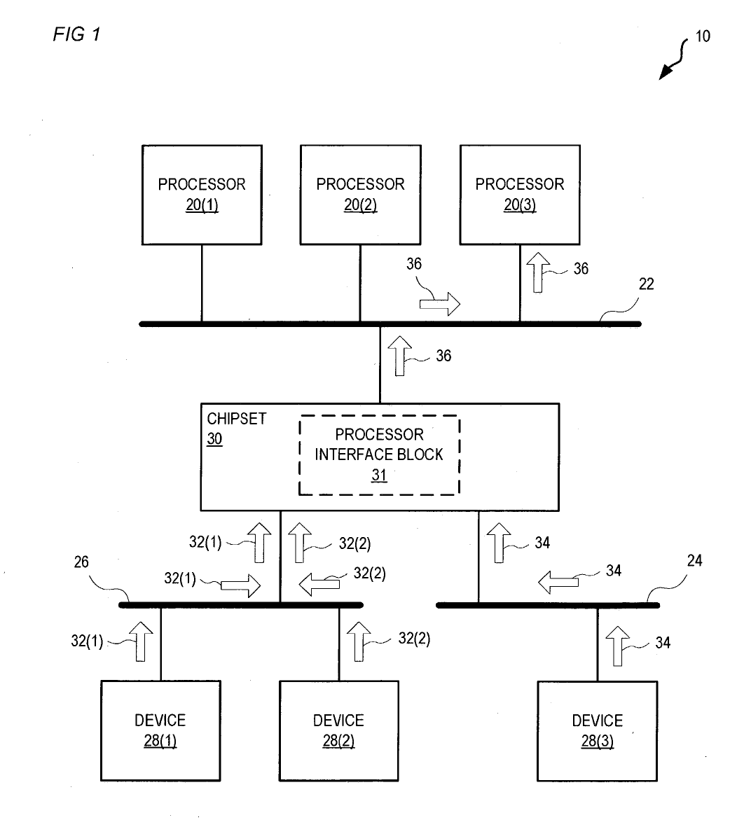

FIG. 1 is a block diagram showing one system 10 that combines a slow data stream 34 with two fast data streams, 32(1) and 32(2), to form a single fast data stream 36. System 10 is illustratively shown with three processors 20(1), 20(2) and 20(3) connected to a processor bus 22, two high speed devices 28(1) and 28(2) connected to a high speed bus 26, and a slow speed device 28(3) connected to a slow speed bus 24. Data streams 32, 34 and 36 represent data communications from devices 28 to processors 20 over buses 24, 28 and 22. A chipset 30 contains a processor interface block (“PIB”) 31 that connects to processor bus 22, high speed bus 26 and low speed bus 24, and operates to facilitate data communication between devices 28 and processors 20.

By way of example, high speed device 28(1) communicates data to PIB 31 in data stream 32(1) over fast bus 26. High speed device 28(2) communicates data to PIB 31 in data stream 32(2) over fast bus 26. Slow speed device 28(3) communicates data to PIB 31 in data stream 34 over slow speed bus 24. PIB 31 communicates data from devices 28 to processor 20(3) in single fast data stream 36 over processor bus 22. High speed devices 28(1) and 28(2) are, for example, random access memory and disk drives. Low speed device 28(3) is, for example, a computer keyboard.

Upon reading and fully appreciating this disclosure, one skilled in the art appreciates that additional data streams may exist within system 10, for example to facilitate data communication from processors 20 to devices 28 over busses 22, 24 and 26. FIG. 1 shows only four data streams 32(1), 32(2), 34 and 36 for clarity of illustration.

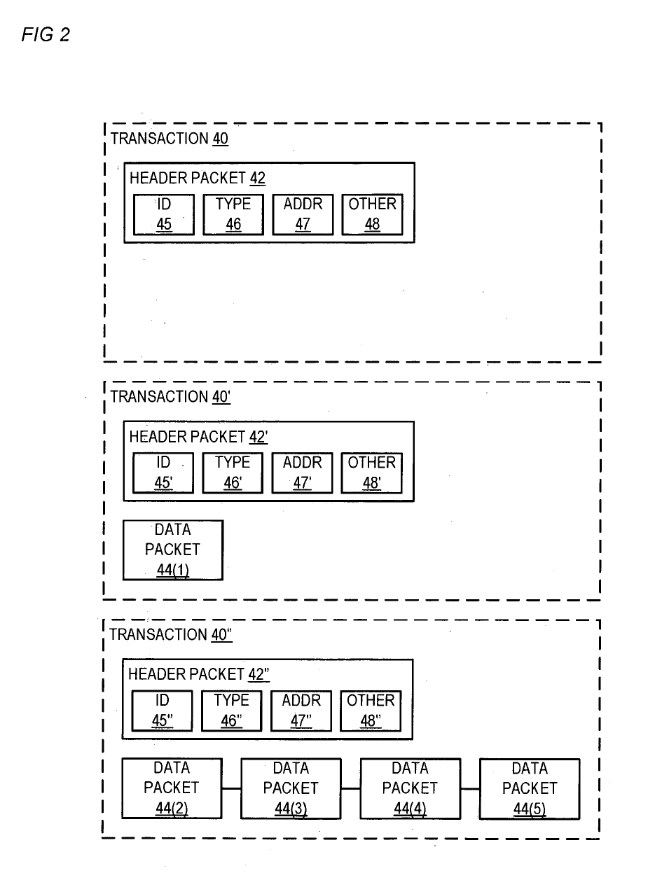

A transaction is a data structure that contains information transferred within data streams 32, 34 and 36. Each transaction has a header packet and, optionally, one or more data packets, as illustrated in FIG. 2. In particular, FIG. 2 shows a block diagram of three exemplary transactions 40 used to transfer information within data streams 32(1), 32(2), 34 and 36. Transaction 40 has a header packet 42 and zero data packets. Transaction 40′ has a header packet 42′ and one data packet 44(1). Transaction 40″ has a header packet 42″ and four data packets 44(2), 44(3), 44(4) and 44(5). Header packets 42, 42′ and 42″ may each respectively contain a transaction ID 45, a transaction type 46, an address 47, and additional information 48, as illustrated. Transaction ID 45 is a unique identifier, used by system 10 to identify transaction 40. Transaction type 46 indicates the type of information and the number of data packets that are included in transaction 40. Address 47 defines a location in memory if transaction 40 is a data transfer. For example, if device 28(1) is a device containing random access memory, address 47 may define a location within the random access memory. Additional information 48 in header packet 42 may include, for example, error codes that operate to verify that information has been transferred without corruption.

It should be apparent from this disclosure that transactions 40, 40′ and 40″ are given as examples of transactions; transactions may consist of other combinations of header and data packets.

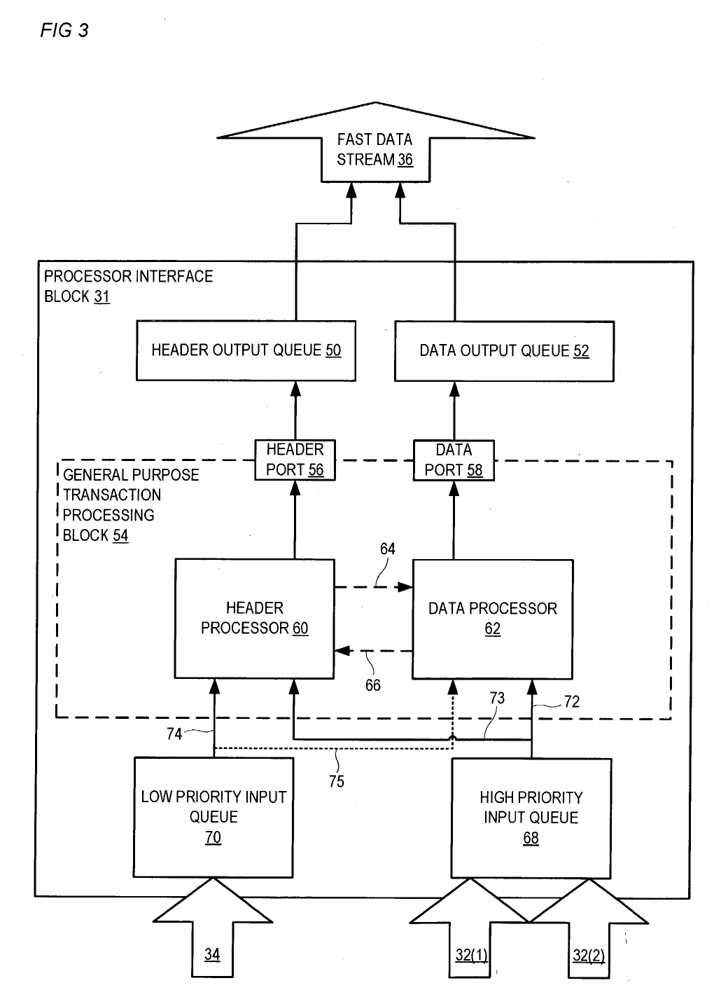

An exemplary embodiment of PIB 31, FIG. 1, is shown in FIG. 3, illustrating data communication from devices 28 to processors 20. As shown, PIB 31 combines fast data streams 32 and slow data stream 34 into single fast data stream 36. PIB 31 is illustratively shown with a general purpose transaction processing block 54, which includes a header processor 60 and a data processor 62. Header processor 60 and data processor 62 operate according to control signals 64, 66 between one another to process header packet 42 and data packets 44, respectively. This controlled operation reduces latency and maximizes bandwidth associated with processing transactions 40 within PIB 31, thereby improving performance of system 10.

PIB 31 also includes a high priority input queue 68 and a low priority input queue 70. High priority input queue 68 stores transactions 40 received from fast data streams 32(1) and 32(2). Low priority input queue 70 stores transactions 40 received from slow data stream 34. Low priority input queue 70 and high priority input queue 68 are, for example, latch arrays within PIB 31. High priority input queue 68 is monitored by data processor 62 via a data path 72, to determine the packet type (header packet 42 or data packet 44) at the front of high priority input queue 68. If, for example, header packet 42 is at the front of high priority input queue 68, data processor 62 informs header processor 60, through control signal 66, to read header packet 42 from high priority input queue 68; header processor 60 in turn reads the header packet of high priority input queue 68 over a data path 73. If, on the other hand, data packet 44 is at the front of high priority input queue 68, data processor 62 reads data packet 44 from high priority input queue 68 over data path 72.

In one embodiment, low priority input queue 70 is monitored by header processor 60 via a data path 74. Header processor 60 reads a header packet 42 from low priority input queue 70 only if header processor 60 has finished processing all header packets 42 from high priority input queue 68. In this situation, header processor 60 notifies data processor 62, through control signal 64, to read data packets 44 from low priority input queue 70; when data processor 62 completes processing of current transactions and there are no queued transactions, data processor 62 then processes data packets from low priority input queue 70 over data path 75.

A “current” transaction includes a transaction from one or more fast data streams that is currently being processed by the data processor; data packets associated with the current transaction may still exist within a high priority input queue. A “queued” transaction includes a transaction from one or more fast data streams that is stored in the high priority input queue and has at least a header packet. A current transaction “completes” when there are no further data packets of the current transaction in the high priority data queue.

Optionally, header processor 60 may instruct data processor 62 to generate data packet(s) 44 associated with header packet 42 in low priority input queue 70. Accordingly, in one embodiment, data path 75 is not used within PIB 31.

In another embodiment, data processor 62 informs header processor 60, by control signal 66, that no further transactions exist in high priority input queue 68; header processor 60 in turn monitors low priority input queue 70, via data path 74. If a header packet 42 exists in low priority input queue 70, header processor 60 processes the header packet and informs data processor 62, by control signal 64, to process or generate data packets 44 associated with the low priority header packet 42.

Header processor 60 is, for example, a state machine that interacts with data processor 62 via control signals 64 and 66 to coordinate processing of transactions 40 from low priority input queue 70. Header processor 60 thereby inserts transactions 40 from low priority input queue 70 into single fast data stream 36 such that current transactions from high priority input queue 68 are not corrupted or delayed.

Header processor 60 reformats header packet 42 to match the format of single fast data stream 36, if necessary, and sends header packet 42 to a header output queue 50 via a header port 56. Header output queue 50 is, for example, a latch array within PIB 31. Header port 56 is an interface between general purpose transaction processing block 54 and header output queue 50; it may include ratio logic to facilitate transferring data from one clock frequency domain to another (e.g., from within block 54 to outside block 54). Header output queue 50 stores header packets 42 prior to output into single fast data stream 36 (i.e., over bus 22, FIG. 1).

Data processor 62 reformats data packets 44 into the format of single fast data stream 36, if necessary, and sends data packets 44 to a data output queue 52 via a data port 58. Data output queue 52 is, for example, a latch array within PIB 31. Data port 58 is an interface between general purpose transaction processing block 54 and data output queue 52; it may include ratio logic to facilitate transferring data from one clock frequency domain to another (e.g., from within block 54 to outside block 54). Data output queue 52 stores data packets 44 prior to output into single fast data stream 36. Single fast data stream 36 conveys the combined header and data packets to processor 20 over bus 22, FIG. 1.

Communication may also occur in reverse order, from processors 20 to devices 28. Accordingly, PIB 31 may also include known functionality that facilitates such reverse data communication; however such functionality is not shown for clarity of illustration. Moreover, those skilled in the art appreciate that devices 28, FIG. 1, also typically include interface blocks to process transactions to and from PIB 31.

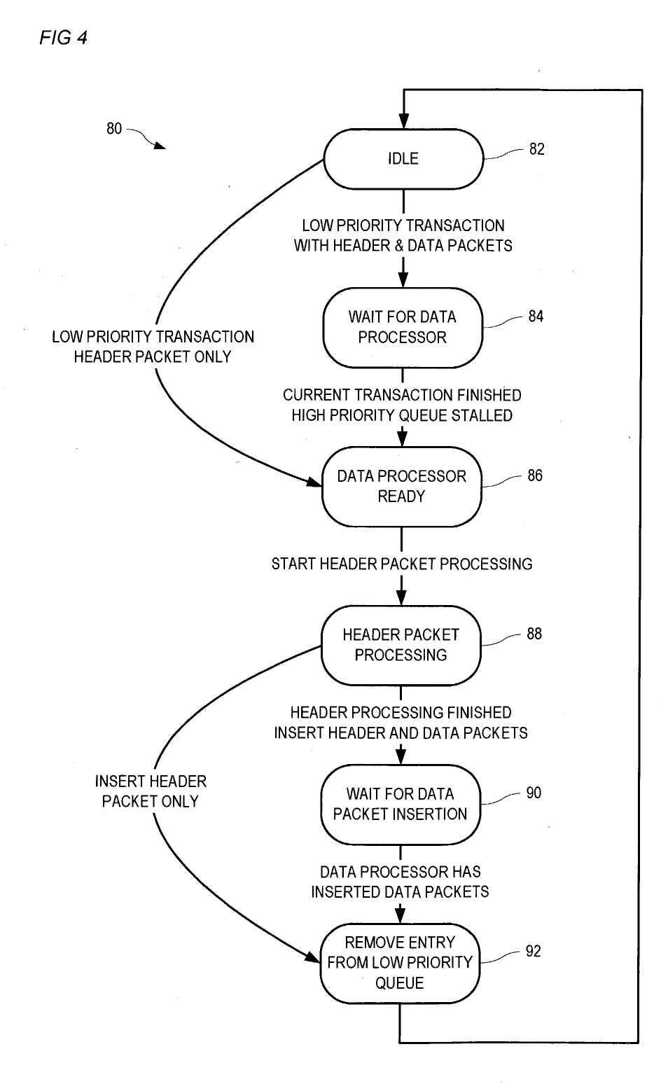

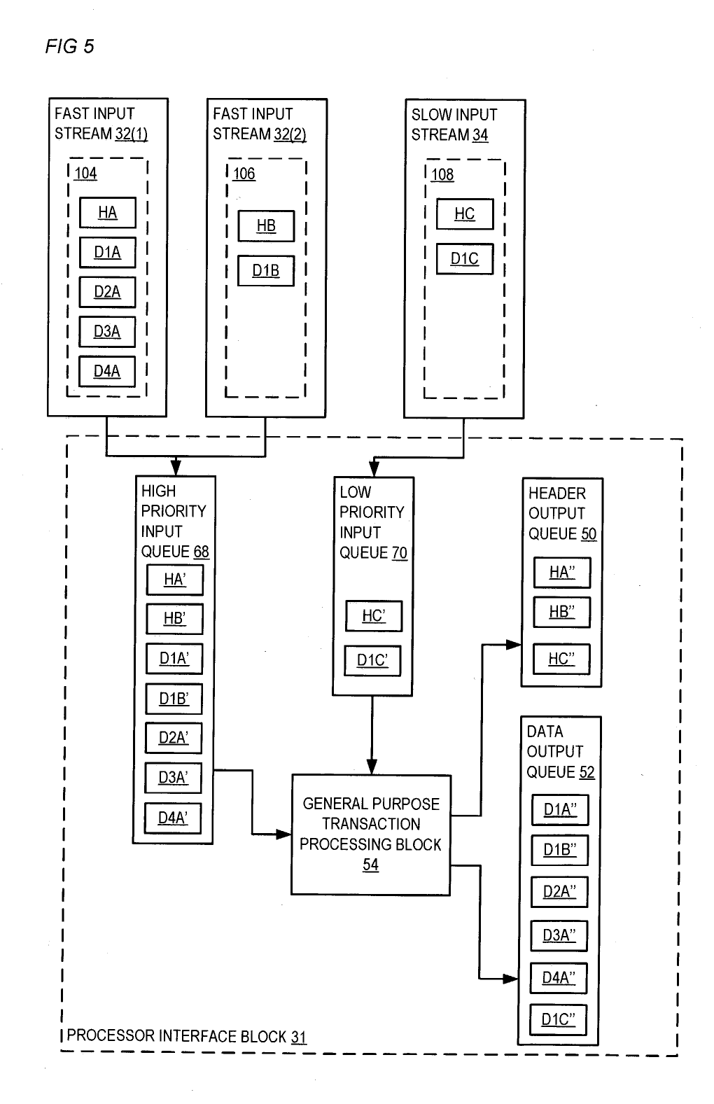

FIG. 4 is a diagram illustrating exemplary state machine transition logic 80 used within header processor 60, FIG. 3. FIG. 5 is a block diagram illustrating exemplary data used within state machine transition logic 80. In an illustrative example, fast data stream 32(1) has one transaction 104 constructed of one header packet HA and four data packets D1A, D2A, D3A and D4A. Fast data stream 32(2) has one transaction 106 constructed of one header packet HB and one data packet D1B. In the example, transaction 104 arrives at high priority input queue 68 concurrently with transaction 106; therefore individual packets of transactions 104 and 106 become interleaved and stored as header packets HA′, HB′ and data packets D1A′, D1B′, D2A′, D3A′ and D4A′ in high priority input queue 68, as shown in FIG. 5. Slow data stream 34 has one transaction 108 constructed of one header packet HC and one data packet D1C. Transaction 108 is stored in low priority input queue 70 as header packet HC′ and data packet D1C′, as shown.

In operation, data processor 62 instructs header processor 60 (via control signal 66) to process header packets HA′ and HB′ from high priority input queue 68. Header processor 60 sends processed header packets HA″ and HB″ to header output queue 50. Concurrently, data processor 62 processes data packets D1A′, D1B′, D2A′, D3A′ and D4A′ from high priority input queue 68 and sends processed data packets D1A″, D1B″, D2A″, D3A″ and D4A″ to data output queue 52. The processing time for individual header and data packets may differ; and the order in which header packets HA″ and HB″ are sent to single fast data stream 36, relative to data packets D1A″, D1B″, D2A″, D3A″ and D4A″, is indeterminate. However, if header packet HA′ is received by PIB 31 before header packet HB′, header packet HA″ is sent to header output queue 50 prior to header packet HB″. Likewise, data packets D1A′, D1B′, D2A′, D3A′ and D4A′ are sent to data output queue 52 in the order in which they are received.

State machine transition logic 80, FIG. 4, thus illustrates an exemplary communication protocol between header processor 60 and data processor 62 to process packets HC′ and D1C′ from low priority input queue 70. Header processor 60 transitions to an idle state 82 after processing a header packet from a data stream 32, 34; it continually monitors low priority input queue 70 and informs data processor 62 when there is a transaction (e.g., transaction 108) to process.

In one example, data processor 62 informs header processor 60, by control signal 66, that no further transactions are queued in high priority input queue 68 and that header processor 60 may process low priority input queue 70. Data processor 62 then becomes slave to header processor 60 during the processing of transaction 108 of low priority input queue 70. However, header processor 60 only processes one transaction of low priority input queue 70 before returning control to data processor 62, to ensure quick processing of queued transactions that arrive in high priority queue 68 during processing of low priority queue 70.

Header processor 60 analyzes header packet HC′ to determine the number of data packets, if any, associated with transaction 108. In this example, there is one data packet D1C′ associated with header packet HC′. Since header processor 60 is in wait state 84, data processor 62 can thus process current transactions of high priority input queue 68, and header processor 60 does not send header packet HC′ to header output queue 50 until data processor 62 signals that all data packets (i.e., D1A′ . . . D4A′, D1B′) for current transactions are complete.

Before attempting to process data packet D1C′ of low priority input queue 70, data processor 62 thus continues to process current transactions corresponding to previously processed header packets from high priority input queue 68. In this example, processing of transactions 104 and 106 has started; therefore, data processor 62 continues until data packets D1A″, D1B″, D2A″, D3A″, and D4A″ have been sent to data output queue 52. When data processor 62 completes its processing of current transactions of high priority input queue 68, it sends a signal to header processor 60, via control signal 66, indicating it is free to process data packets (e.g., D1C′) from low priority input queue 70.

When header processor 60 receives this signal over control signal 66, header processor 60 transitions to a data processor ready state 86. Header processor 60 then continues to translate header packet HC′ into the format required by single fast data stream 36 and then transitions to a header processing state 88.

In one embodiment, when processing of header packet HC′ of low priority input queue 70 is complete, header processor 60 signals data processor 62, via control signal 64, to start processing data packet D1C′ from low priority input queue 70. Header processor 60 sends the translated header packet HC″ to header output queue 50 and transitions to a wait state 90. Data processor 62 reads data packet D1C′ from low priority input queue 70 and converts it into the format required by single fast data stream 36. Data processor 62 then sends data packet D1C″ to data output queue 52 and sends a signal to header processor 60, via control signal 66, indicating that data packet processing is complete.

In another embodiment, a transaction 40 received via low priority input queue 70 has zero data packets 44 but its header packet 42 identifies data associated with transaction 40. In this case, header processor 60 may optionally instruct data processor 70, via control signal 64, to generate data packet(s) 44 for the transaction. After generating the data packet(s), data processor 62 informs header processor 60, via control signal 66, that the data packet(s) are created and forwarded to data output queue 52.

When the signal from data processor 62 is received by header processor 60, indicating that data processor 62 has either completed processing data packet D1C′ or generated data packet(s) 44 requested by header processor 60, header processor 60 transitions to a remove entry state 92, where it removes transaction 108 from low priority input queue 70. Header processor 60 then signals data processor 62, via control signal 64, indicating that data processor 62 resume processing of high priority input queue 68, though optionally data processor 62 may resume processing of high priority input queue 68 automatically. Header processor 60 then transitions back to idle state 82 and resumes processing of high priority input queue 68 when requested by data processor 62 over control signal 66.

If a transaction 40 is received from slow data stream 34 containing a header packet and zero data packets, header processor 60 may insert the header packet into header output queue 50 without interaction with data processor 62, as data packet ordering will not be disturbed (e.g., the header packet is inserted to the single fast data stream using clock cycles unoccupied by transactions from the high priority queue 68). Header processor 60 may therefore transition from idle state 82 to data processor ready state 86 when transaction type 46 of header packet 42 indicates zero data packets. Header processor 60 may also transition from header processing state 88 to remove entry state 92 when there are zero data packets to be processed by data processor 62.

Accordingly, PIB 31 may thus combine transactions from slow data stream 34 into single fast data stream 36 without corrupting or delaying transactions of fast data streams 32.

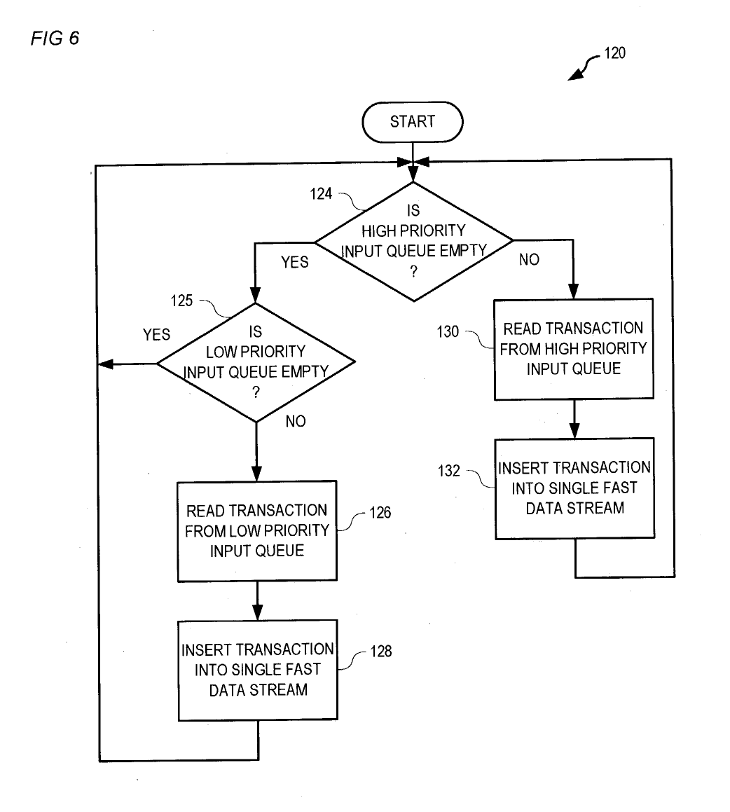

FIG. 6 is a flowchart illustrating one process 120 for combining a slow data stream and one or more fast data streams into a single fast data stream. Step 124 is a decision. If high priority input queue 68 is empty, process 120 continues with step 125; otherwise process 120 continues with step 130. Step 124 ensures that all transactions received in high priority input queue 68 are processed and output to single fast data stream 36 without being corrupted or delayed by a transaction received in low priority input queue 70.

Step 125 is a decision. If low priority input queue 70 is empty, process 120 continues with step 124; otherwise process 120 continues with step 126. If low priority input queue 70 is empty there are no transactions to output to single fast data stream 36.

Step 126 reads a transaction 40 from low priority input queue 70. Step 128 inserts transaction 40, read in step 126, into single fast data stream 36. As high priority input queue 68 is empty, as decided in step 124, transaction 40 may be inserted into single fast data stream 36. Process 120 continues with step 124.

Step 130 reads a transaction 40 from high priority input queue 68. Step 132 inserts transaction 40, read in step 130, into single fast data stream 36. Process 120 continues with step 124.

Process 120 illustrates operation of general purpose transaction processing block 54 of PIB 31 to combine slow data stream 34 and fast data streams 32 into a single fast data stream 36. In one embodiment, steps 124, 125 proceed concurrently as header processor 60 may continuously monitor low priority input queue 70 while data processor 62 continually monitors high priority queue 68.

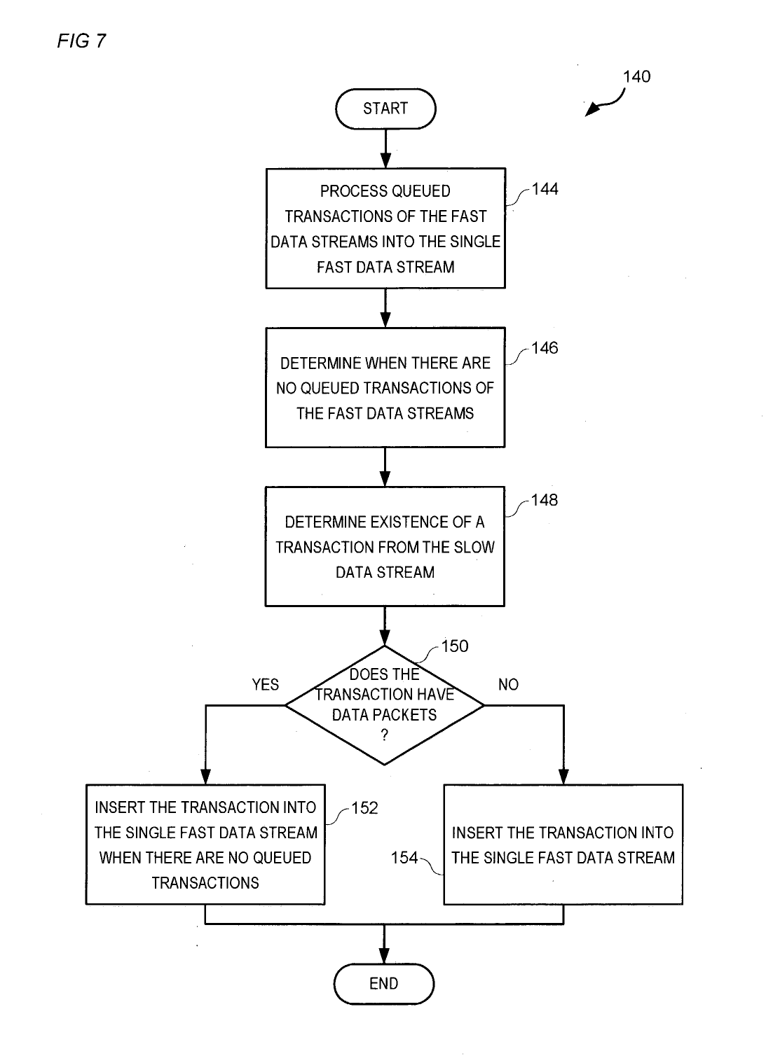

FIG. 7 shows one method 140 for combining a slow data stream with one or more fast data streams into a single fast data stream. In step 144, queued transactions of the fast data streams are processed into the single fast data stream. Step 146 determines when there are no queued transactions of the fast data streams. Step 148 determines the existence of a transaction from the slow data stream. If 150 the transaction has data packets, step 152 inserts the transaction into the single fast data stream when there are no queued transactions. If 150 the transaction has no data packets, step 154 inserts the transaction into the single fast data stream.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for combining a slow data stream with one or more fast data streams into a single fast data stream, comprising the steps of:
processing queued transactions of the fast data streams into the single fast data stream;
determining when there are no queued transactions of the fast data streams;
determining existence of a transaction from the slow data stream;
if the transaction has data packets, inserting the transaction into the single fast data stream when there are no queued transactions; and
if the transaction has no data packets, inserting the transaction into the single fast data stream.

2. The method of claim 1, the step of determining existence of a transaction comprising reading a header packet of the transaction.

3. The method of claim 1, if the transaction has data packets, the step of inserting comprising inserting the header packet and data packets into the single fast data stream after completion of current transactions.

4. The method of claim 1, the step of processing comprising reformatting the queued transactions into a format of the single fast data stream.

5. The method of claim 1, further comprising the step of reformatting the transaction into a format of the single fast data stream.

6. The method of claim 1, the step of determining when there are no queued transactions comprising the step of determining when there are no further header packets of the queued transactions.

7. The method of claim 6, further comprising the step of determining completion of the current transactions by determining whether processing of all data packets of current transactions is complete.

8. The method of claim 7, further comprising the step of communicating a first control signal between a data processor and a header processor when it is determined that all data packets of the current transactions are complete.

9. The method of claim 8, further comprising the step of communicating a second control signal between the header processor and the data processor to initiate processing of the data packets associated with the transaction.

10. The method of claim 9, the data processor generating the data packets associated with the transaction based upon information in the second control signal.

11. The method of claim 9, further comprising the step of stalling processing of new transactions, received from the fast data stream during processing of the transaction, until the data packets associated with the transaction are inserted to the single fast data stream.

12. The method of claim 11, the data processor signaling the header processor after processing the data packets associated with the transaction.

13. A system that combines a slow data stream with one or more fast data streams to form a single fast data stream, comprising:
a header processor for processing header packets of transactions of the slow data stream and the fast data streams into the single fast data stream;
a data processor for processing data packets of transactions of the slow data stream and the fast data streams into the single fast data stream; and
the header processor reading a header packet of a transaction from the slow data stream to determine a number of data packets associated the transaction; if there are data packets associated with the transaction and there are no queued transactions, the header processor inserting the header packet into the single fast data stream after completion of current transactions of the fast data streams by the data processor; if there are no data packets associated with the transaction, the header processor inserting the header packet into the single fast data stream without waiting for completion of the current transactions.

14. The system of claim 13, the data processor signaling the header processor, upon completion of the current transactions, to process the header packet of the transaction.

15. The system of claim 14, the header processor signaling the data processor, after reading the header packet of the transaction, to generate data associated with the transaction.

16. The system of claim 14, the header processor signaling the data processor, after reading the header packet of the transaction, to process data packets associated with the transaction.

17. The system of claim 13, the data processor signaling the header processor upon completion of processing data packets associated with the transaction.

18. The system of claim 13, the header processor formatting the header packets into a header format of the single fast data stream, the data processor formatting the data packets into a data format of the single fast data stream.

19. The system of claim 13, the data processor determining when there are no queued transactions by determining when there are no queued packets of the fast data streams.

20. The system of claim 13, further comprising a high priority input queue for storing (a) the queued transactions and (b) data packets associated with any of the current transactions that have not been processed by the data processor.

21. The system of claim 13, further comprising a low priority input queue for storing the transaction.

22. The system of claim 21, the low priority input queue storing data packets associated with the transaction that have not been processed by the data processor.

23. The system of claim 13, further comprising (a) a header output queue for storing header packets processed by the header processor prior to output to the single fast data stream, and (b) a data output queue for storing data packets processed by the data processor prior to output to the single fast data stream.

24. A system for combining a slow data stream with one or more fast data streams into a single fast data stream, comprising the steps of:
means for processing queued transactions of the fast data streams into the single fast data stream;
means for determining when there are no queued transactions of the fast data streams;
means for determining existence of a header packet of a transaction from the slow data stream;
means for processing a header packet of the transaction from the slow data stream to the single fast data stream when there are no data packets associated with the transaction; and
means for processing one or more data packets of the transaction from the slow data stream into the single fast data stream when there are no queued or current transactions.
